(19) United States
(12) Patent Application Publication
(10) Pub. No.: US 2015/0317726 A1
(43) Pub. Date: Nov. 5, 2015

(54) GOAL PLANNING SYSTEM AND METHOD

(71) Applicant: Allianz Global Investors U.S. LLC, New York, NY (US)

(72) Inventor: Shlomo Benartzi, Los Angeles, CA (US)

(21) Appl. No.: 14/701,878

(22) Filed: May 1, 2015

Related U.S. Application Data
(60) Provisional application No. 61/987,261, filed on May 1, 2014.

(51) Int. Cl. G06Q 40/00; G06Q 40/06

(52) U.S. Cl. CPC G06Q 40/00; G06Q 40/06

(57) ABSTRACT

A method of identifying and prioritizing goals for retirement is provided. The method comprises obtaining by a computer a list of goals from a user to create a first list and providing a list of pre-selected goals to the user. The user's preferred goals are obtained by a computer from the list of pre-selected goals to create a second list and the first list and the second list are combined into a combined list. In the next step, the goals are prioritized by a computer on the combined list based on the user's preferences. A first question is proposed by a computer to the user and the user's response to the first question is recorded by a computer. The goals are reprioritized by a computer on the combined list based on the user's preferences.

### RELATED APPLICATIONS

This application claims priority to U.S. Provisional Application No. 61/987,261, entitled “Goal Planning System and Method” and filed May 1, 2014, the contents of which are hereby incorporated by reference in their entirety.

### TECHNICAL FIELD

The technical field relates to the field of financial services, and in particular to a new system and method of goal planning, including computer based tools and kits for goal planning.

### BACKGROUND

Many different financial calculators exist which financial advisors or individual investors can use to help the investor identify and reach their financial goals. Typically, these tools ask the user for information such as desired retirement age, desired annual income after retirement, vacation budgets after retirement, and desired estate value at death. Some calculators also ask about the investor's risk tolerance so that an advisor can suggest investments within the individual's comfort level.

Other tools exist that calculate and suggest investment or savings amounts to match up with the investor's financial goals. For example, a simple online calculator allows an investor to input their present age, their desired retirement age, and their desired savings rate at a percentage of their present income. The tool identifies the total amount of money needed for retirement at the chosen age, and whether, at the current rate of savings, an investor will meet that goal. This type of online calculator is broadly available, and while easy to use, generates a very simple report that fails to take into account any of the investor's specific goals other than the overall value of the retirement portfolio.

Another available tool for a financial advisor is a questionnaire that asks the investor what their goals are and what their risk tolerance is. Risk tolerance is typically calculated using standard tools such as mathematical computation of standard deviation, semi-variance and determining the highest level of losses an investor is comfortable with during an investment time frame. The advisor could also inquire as to what amount of each type of asset the investor is willing to put into different risk levels of investments. The results are then used to formulate a recommended allocation into certain investment vehicles. These allocations are then often tested using a Monte Carlo simulation that may be based on assumptions of capital markets and/or samples of historical data, and the results of these simulations are used to convey a confidence level or a percentage of success or failure to achieve a desired income level at the point of the client's retirement.

Another tool that may be used by financial advisors and/or investors is a social security benefits evaluator. This type of tool calculates what a person's social security benefits will be at retirement based on how much the person earned over their career, their desired retirement age, whether there are spousal benefits and whether there are survival benefits for a surviving spouse.

Simple numeric tools in the form of iPhone or iPad applications also exist for this purpose. These applications ask a user to identify their investment preferences and objectives. Sample inquiries include: “Are you a sophisticated investor?” “Do you think you will live a long life?” “How important is it for you to leave a financial legacy when you pass away?” “Do you need income that is guaranteed to last for a lifetime?” “Are you willing to accept the ups and downs in asset value and/or income value in exchange for potential growth?” and “How important is it to have your income protected from market downturns?” These questions are often answered with a ranking such as “Most important,” “Least important,” and “No strong preference.” After a user answers these questions, the tool displays a chart of the user's assets over a period of time and notes whether the user will meet their retirement goals. An option to adjust their monthly savings, retirement age and risk tolerance is also available.

One drawback to known tools is that they do not offer any meaningful help to the investor in terms of identifying and prioritizing their retirement goals.

There remains a need for a tool that leverages behavioral science to assist individuals in identifying and prioritizing their goals. With the present method, tools can be implemented that remove behavioral obstacles in identifying and prioritizing an individual's goals. Once the behavioral obstacles are removed, and goals are identified and prioritized, a more meaningful and accurate plan can be designed for the user. The present tool can be useful in a variety of areas, especially for retirement goal planning.

### BRIEF SUMMARY

In a first aspect, a method of identifying and prioritizing goals for retirement, comprises obtaining by a computer a list of goals from a user to create a first list and providing a list of pre-selected goals to the user. The user's preferred goals are obtained by a computer from the list of pre-selected goals to create a second list and the first list and the second list are combined into a combined list. In the next step, the goals are prioritized by a computer on the combined list based on the user's preferences. A first question is proposed by a computer to the user and the user's response to the first question is recorded by a computer. The goals are reprioritized by a computer on the combined list based on the user's preferences.

In a second aspect, a method of identifying and prioritizing goals for retirement comprises a system comprising obtaining by a computer a list of goals from a user to create a first list and providing by a computer a list of pre-selected goals to the user. The user's preferred goals from the list are obtained by a computer from the list of pre-selected goals to create a second list and the first and second lists are combined into a combined list by a computer. The goals are prioritized by a computer on the combined list based on the user's preferences and the computer proposes a first question to the user and records the user's response to the first question. The computer proposes a second question to the user and records the user's response to the second question. The computer proposes a third question to the user and records the user's response to the third question. The computer then reprioritizes the goals on the combined list based on the user's preferences.

In a third aspect, a method of identifying and prioritizing goals for retirement is provided, comprising recording a list of goals from a user to create a first list and providing a list of pre-selected goals to the user. The user's preferred goals from the list of pre-selected goals are recorded to create a second list and the first list and the second list are combined into a combined list. The goals are prioritized on the combined list based on the user's preferences and a first question is proposed to the user and the user's response to the first question is recorded. The goals on the combined list are reprioritized based on the user's preferences.

In a fourth aspect, a computer-readable storage medium having computer-readable code for identifying and prioritizing goals for retirement stored therein comprises computer-usable program code for obtaining a first list of goals from a user, computer-usable program code for providing a second list of goals to the user, computer-usable program code for allowing a user to combine at least parts of the first and second lists of goals, computer-usable program code for storing the combined first list and second list of goals as a third list of goals, computer-usable program code for allowing the user to organize the third list of goals by the user's preference, computer-usable program code for storing the organized third list, computer-usable program code for displaying at least one question to the user and computer-usable program code for allowing the user to reorganize the third list of goals after displaying the at least one question.

### BRIEF DESCRIPTION OF THE DRAWINGS

FIG. 1 is a flow chart showing the steps of the new method.

FIG. 2 is sample of a page for a kit for use with the new method showing step 1.

FIG. 3 is sample of a master list of goals for use with the kit of the new method showing step 2a.

FIG. 4 is a sample of a page for a kit for use with the new method showing step 2b.

FIG. 5 is a sample of a page for a kit for use with the new method showing step 3a.

FIG. 6 is a sample of a page for a kit for use with the new method showing step 3b.

FIG. 7 is a sample of a page for a kit for use with the new method showing step 3b.

FIG. 8 is a sample of a page for a kit for use with the new method showing step 4a.

FIG. 9 is a sample of a page for a kit for use with the new method showing step 4b.

FIG. 10 is a sample of a page for a kit for use with the new method showing step 5.

FIG. 11 is a sample of a page for a kit for use with the new method showing step 6.

FIG. 12 is a sample of a page for a kit for use with the new method showing step 7.

FIG. 13 is a sample screen for a computer application for use with the new method showing step 1.

FIG. 14 is a sample screen for a computer application for use with the new method showing step 2.

FIG. 15 is a sample screen for a computer application for use with the new method showing step 2.

FIG. 16 is a sample screen for a computer application for use with the new method showing step 2.

FIG. 17 is a sample screen for a computer application for use with the new method showing step 2.

FIG. 18 is a sample screen for a computer application for use with the new method showing step 3.

FIG. 19 is a sample screen for a computer application for use with the new method showing step 3.

FIG. 20 is a sample screen for a computer application for use with the new method showing step 3.

FIG. 21 is a sample screen for a computer application for use with the new method showing step 3.

FIG. 22 is a sample screen for a computer application for use with the new method showing step 4a.

FIG. 23 is a sample screen for a computer application for use with the new method showing step 4b.

FIG. 24 is a sample screen for a computer application for use with the new method showing step 5.

FIG. 25 is a sample screen for a computer application for use with the new method showing step 5.

FIG. 26 is a sample screen for a computer application for use with the new method showing step 6.

FIG. 27 is a sample screen for a computer application for use with the new method showing step 6.

FIG. 28 is a sample screen for a computer application for use with the new method showing step 7.

FIG. 29 is a sample screen for a computer application for use with the new method showing step 7.

### DETAILED DESCRIPTION

While the subject matter of this disclosure can be practiced and carried out in many different ways, certain specific embodiments are shown in the drawings and described in detail with the understanding that such drawings and description are exemplary in nature and are not intended to limit the scope of the invention set forth in claims only to those embodiments that are illustrated and described.

A new method and system of goal planning is presently disclosed which implements behavioral science to assist an individual investor in identifying and prioritizing their goals by avoiding behavioral obstacles to identifying the goals. Once the behavioral obstacles are removed, and goals are identified and prioritized, a more meaningful and accurate plan can be designed for the user to reach their goals. The system helps the individual to make a better list and prioritization of goals and can measure the difference between an initial set and ranking of goals and a set and ranking of goals after behavioral obstacles have been removed. The system is particularly suited for helping users address significant decisions where there are gaps between salient attributes and a user's preferences (which includes preferences that may be constructed). These decisions include those that have large value, large risk, large consequences and/or are potentially irreversible and that are also infrequently encountered or addressed. While this is not an exhaustive list, some such decisions are planning for retirement, buying a house, buying a car, or choosing a career. In its most general sense, the system implements a series of steps that helps a user identify, prioritize and then reprioritize their goals after asking them to answer questions designed to eliminate certain behavioral obstacles.

First, a user engages in value focused thinking, blind spot identification and goal prioritization exercises. Then, the user is asked to rethink their prioritized goals using behavioral techniques such as prospective hindsight, recognizing limits of forecasting and learning from others. In total, these steps result in an individual thinking about and reprioritizing their goals in a way that is more meaningful and relevant for providing planning advice to meet their goals.

The new method has many advantages over the old methods in the field. It helps users avoid psychological pitfalls such as focusing on alternatives versus values, encountering blind spots based on difficulties between recall and recognition, avoiding tradeoffs, and thinking too narrowly in terms of the variability of outcomes, preferences over time, and perspectives of others. It leverages psychological tools such as value-focused thinking, a master list, a prioritization board, prospective hindsight, affective forecasting, and expanding thinking using the wisdom of others. And, it allows the user to see and measure changes in goals based on thinking and rethinking certain areas.

The new method can be embodied in many different forms, including without limitation, as a physical set of tiles used for categorizing and weighting different goals, in a computer readable format such as a computer program or application for an iPad or the like, or as a set of worksheets provided to the user or advisor. Each of these embodiments will be described in turn.

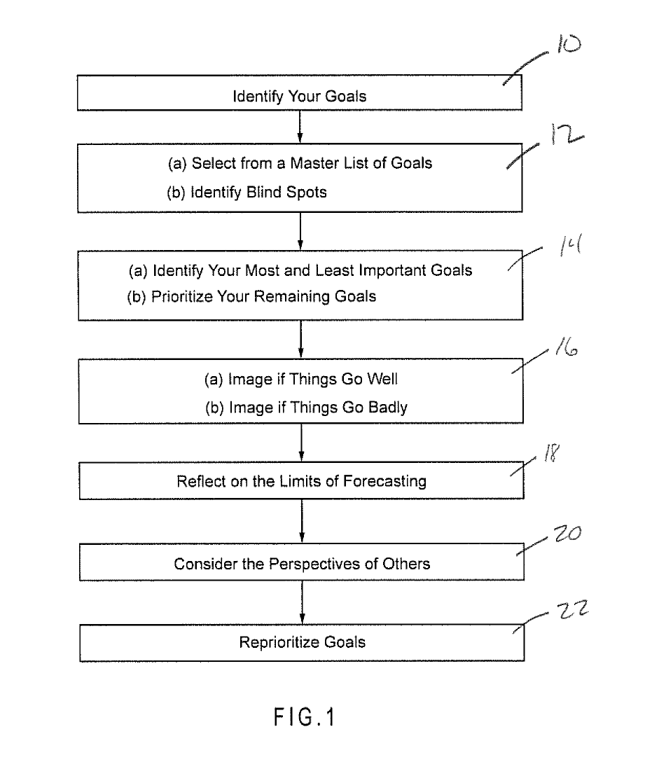

Generally, the new goal planning system and method comprises a set of seven steps that is used to assist the user in identifying and prioritizing their goals when planning for certain events. Referring to FIG. 1, a flowchart generally illustrates the steps of the new goal setting method. In the first step 10, the user creates a self-generated list of goals. These goals could include, for example, achieving financial independence, saving for long term or supplemental health care, buying a home, going on vacation, planning for a second career, continuing their education, passing along wealth to one's children or significant other, donating to charity, saving for assisted living later in life, and saving for retirement.

In the second step 12, the user identifies areas where they may have underestimated their needs when self-generating a list of goals. In the second step 12, the user selects goals from a master list of goals provided to them. After selecting goals from the master list, these selected goals are compared to the user-generated list from step one. The original list from step one 10 is modified to incorporate any additional goals selected from the master list. The goals added from the master list are considered to be “blind spots” and can provide insight into where the user may be underestimating their needs.

In the third step 14, the user prioritizes their goals. The user may identify their most and least important goals from the modified list of step two 12. The user can then prioritize the remaining goals. These goals can be prioritized as most important, moderately important, and least important. Alternatively, the goals can be put in a specific order, or the goals can be assigned a value, for example on a scale of 1-10, with 10 being the most important. Alternatively, the goals can be grouped into most, moderately and least important groups rather than put into a specific order. The goals may be prioritized into a visual matrix.

After the first three steps, a plan can be devised for the user for meeting the identified and prioritized goals. The plan can be provided, for example, by a financial advisor or a computer program, using additional information about the user, such as age, current level of assets, etc. Alternatively, further modification of the goals can be made after additional questions are presented to the user as shown in steps four through seven, below. In these steps the user implements prospective hindsight (step four 16), recognition of limits of their own forecasting (step five 18), learning from others (step six 20) and then reprioritizing their goals (step seven 22).

In the fourth step 16, the user uses prospective hindsight to examine certain scenarios. For example, they may be asked to imagine what would happen if things go well (or poorly) in terms of their prioritized goals from step three 14. One such question could be “Imagine it is 20 years from now. Can you imagine what your life would be like if your retirement went well? How would you describe this situation in terms of your goals?” The answers to these questions could be verbally given to an advisor, written down by the user, or input to or recorded by a computer or other recording device. Next, the user may be asked questions that cover what they might imagine would happen if things went poorly. One such question could be “Imagine it is 20 years from now. Can you imagine what your life might be like if your retirement went badly? How would you describe this situation in terms of your goals?” Once again, the answers to these questions could be verbally given to an advisor, written down by the user, or input to or recorded by a computer or other recording device.

In the fifth step 18, the user is asked to reflect on the limits of their own forecasting. For example, they may be asked whether, when they were 20 years old, they would have predicted that the identified goals would be their goals? This forces the user to think about what they really value today as opposed to what they valued when they were younger. The answers to these questions could be verbally given to an advisor, written down by the user, or input to or recorded by a computer or other recording device.

Next, in the sixth step 20, the user considers the perspective of others to expand their thinking regarding prioritized goals and goals that may change over time. For example, they may be shown the prioritized goals of another person and that person's circumstances will be described. The user is then asked to consider why that person might have prioritized their goals in that fashion. For example, the user may be shown the prioritized goals of a 65 year old female with 2 children whose number one priority is travel and leisure and asked “Why might this person have prioritized their goals this way?” The user may be shown a series of persons at different stages in life (e.g., age 65, 75, 85, 95). The answers to these questions could be verbally given to an advisor, written down by the user, or input to or recorded by a computer or other recording device.

As a seventh step 22, after performing all or some of the above steps 4-6, the user may review their list of identified and prioritized goals and possibly reprioritize them in a new matrix based on their answers or what they have learned in the previous steps. This new matrix of prioritized goals may then be used to assist in the creation of a plan designed to meet the goals.

In an additional step of the method, the system can calculate the differences between the user's original weighting of their priorities after step three, and the new weighting after step seven. This can show what thought exercises have the most effect on which types of goals. Additionally, this difference can be visualized in a graph or speedometer-type visual representation if desired.

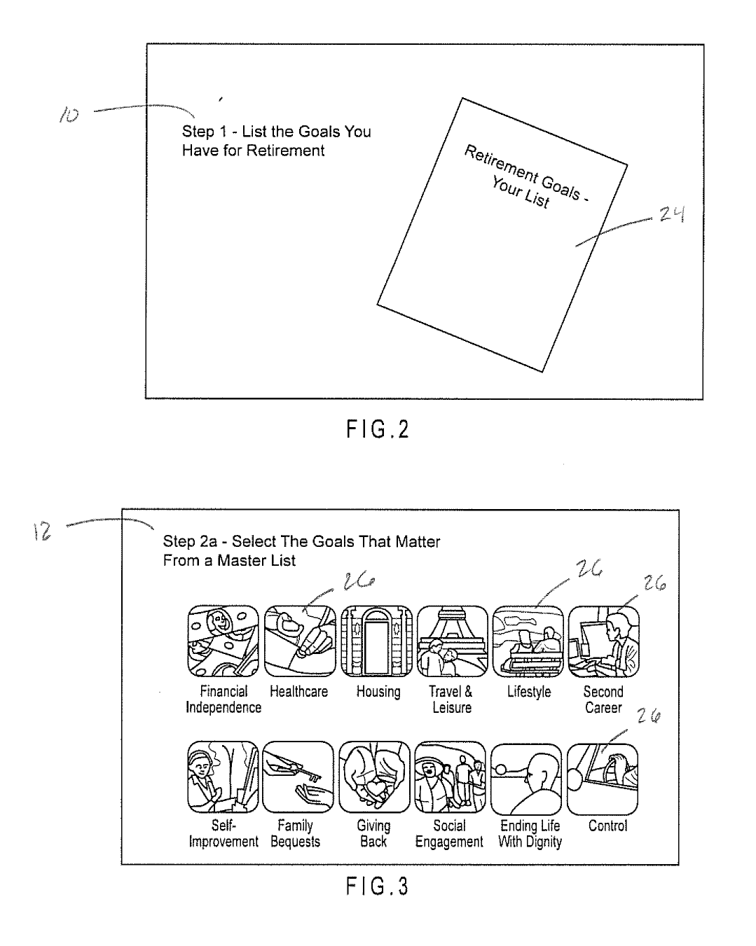

Specific embodiments of the new method will now be described. In a first embodiment, illustrated in FIGS. 2-12, the method is embodied in a tile system kit. The tile system kit may include a set of magnetic tiles utilized in conjunction with a magnetic board, or a set of tiles with Velcro or another attachment mechanism on the back of each tile in conjunction with a Velcro coated board, or other appropriate board based on the tile's attachment mechanism. Another alternative embodiment uses tiles that can simply be placed on a board without any sort of attachment mechanism.

To use the tile system kit, first, the user takes the set of blank tiles 24 to write on. The tiles can also be erased and are reusable. Referring to FIG. 2, in the first step 10 of the method, the user thinks of goals on their own and writes each goal on a separate tile 24. This step, and the others below, may be illustrated on pages or prompted by a computer program that shows the instructions on the screen (similar to the pages or screens shown in in FIGS. 2-12). These pages or screens may also illustrate examples, and, in the case of the computer instructions, await confirmation that each step has been completed before prompting the user to go to the next step.

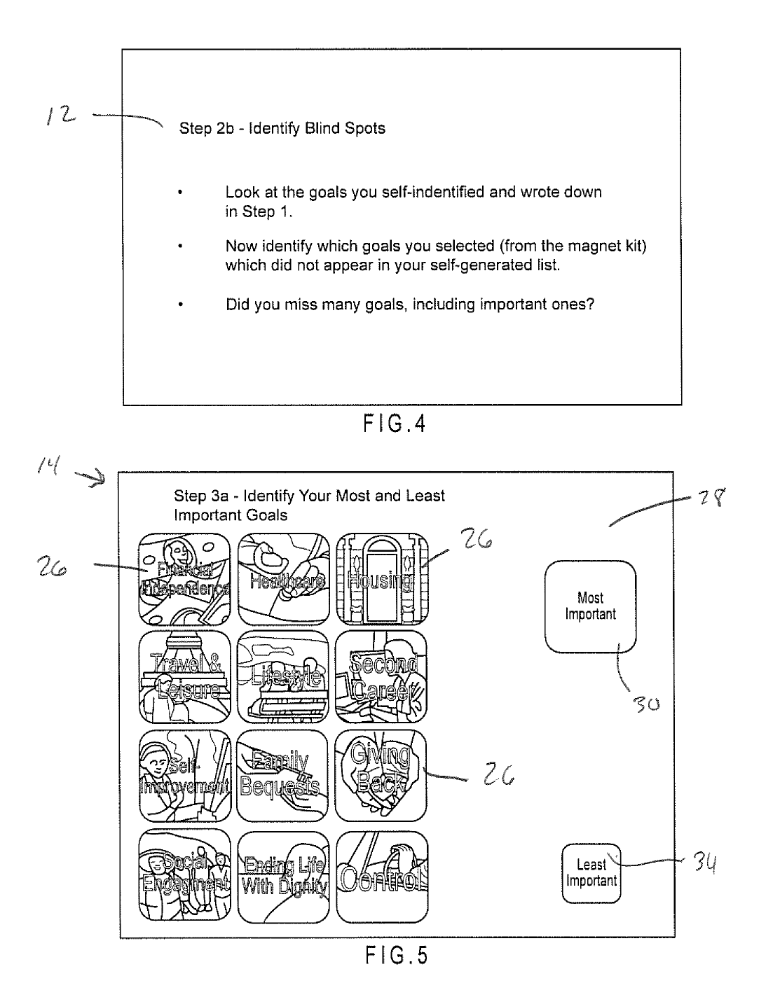

For the second step 12, as shown in FIG. 3, the kit includes a set of tiles 26 with goals already illustrated on them. These goals can be things such as Financial Independence, Healthcare, Housing, Travel & Leisure, Lifestyle, Second Career, Self-Improvement, Family Bequests, Giving Back, Social Engagement, Ending Life With Dignity, and Control. It should be noted that this list is by no means all-inclusive and the method encompasses any goals that one skilled in the art would contemplate. In this step 12 (as shown in FIG. 4), the user is asked to look at their original goals and then selects goal tiles 26 from the supplied set which were not in their original list and adds them to the goals they have already written on the blank tiles 24. As shown, the number of tiles to be selected is 12, however this number may be more or less.

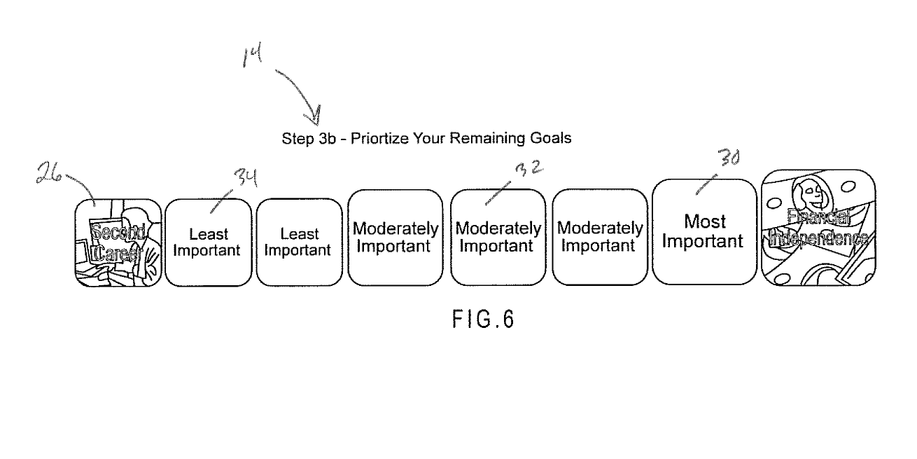

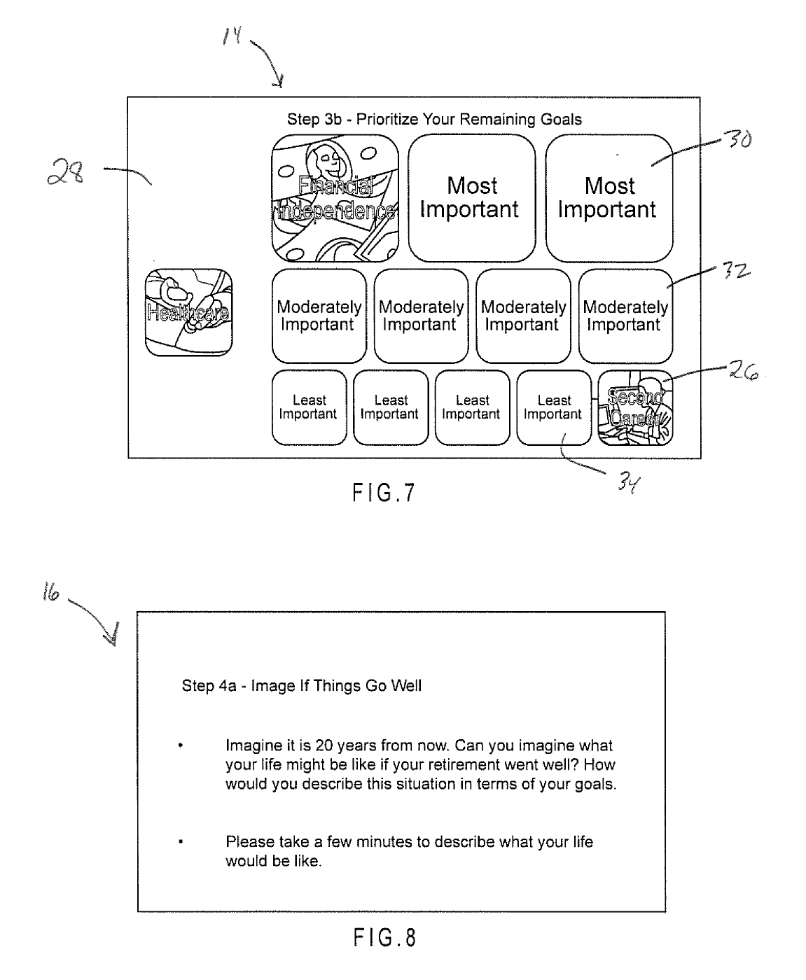

In the third step 14, the user places these tiles on a board 28 such as the one shown in FIG. 5. This board 28 allows the user to prioritize the goals. The user could simply arrange the tiles 24, 26 in a line from least important to most important, as shown in FIG. 6. Alternatively, as shown in FIG. 5, the board 28 includes various sized boxes that are categorized as “Most Important” 30, “Moderately Important” 32, and “Least Important” 34. The user puts all their tiles 24, 26 into the appropriate boxes 30, 32, 34 (FIG. 7).

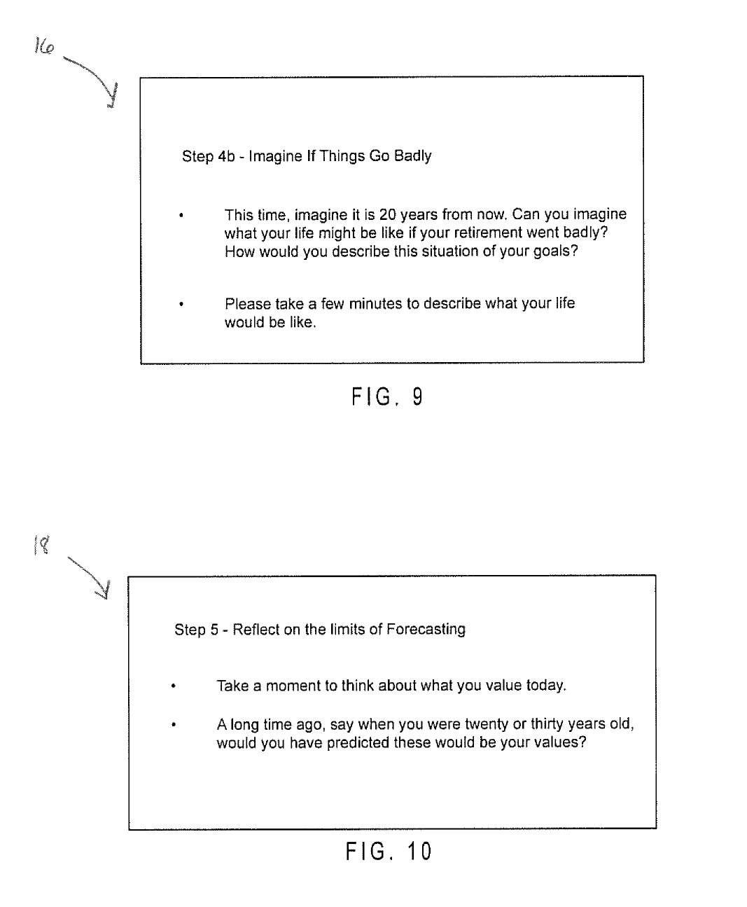

After these steps are performed, the user is asked to rethink their goals through prospective hindsight in the fourth step 16. They are asked what would happen if things go well or poorly in relation to their prioritized goals (FIGS. 8 and 9). The user can record their answers in any method known in the art, such as by hand on a piece of paper or a whiteboard, or their answers can be recorded electronically.

In the fifth step 18, the user reflects on the limits of their forecasting and are asked to think about what they value today, and then to consider whether, when they were younger, would they have predicted that the identified goals and the weight they have assigned to these goals would have been their goals (FIG. 10). Again, the user can record their answers in some fashion, such as by hand on a piece of paper or a whiteboard, or their answers can be recorded electronically.

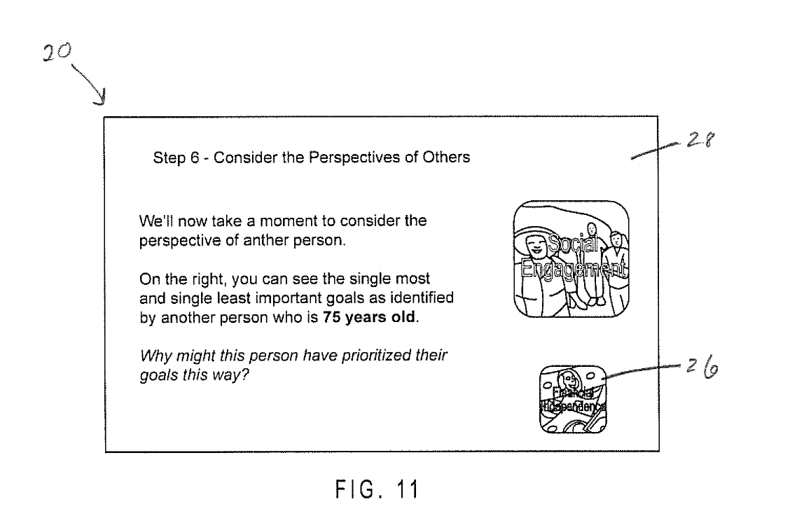

For the sixth step 20, the kit can include tiles 24, 26 such as those shown in FIG. 11, which show the perspective of others. For example, the kit could have an illustration or a tile set depicting the goals and priorities of a 65 year old woman with 2 children whose top priority is travel and leisure. The user is instructed to consider why that person would have prioritized their goals in that way.

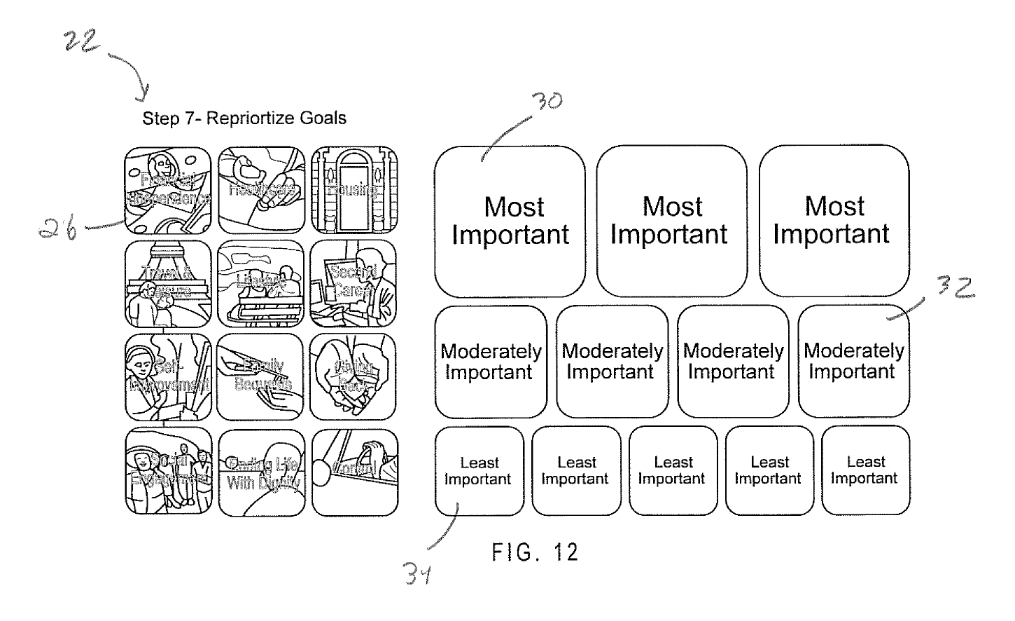

In the seventh step 22, the individual is asked to reprioritize and reorder the tiles 24, 26 from FIG. 7 based on what they have learned from steps four 16, five 18 and six 20. Once the tiles 24, 26 are rearranged, this new matrix (FIG. 12) of prioritized goals may be used to assist in the creation of a plan designed to meet the goals.

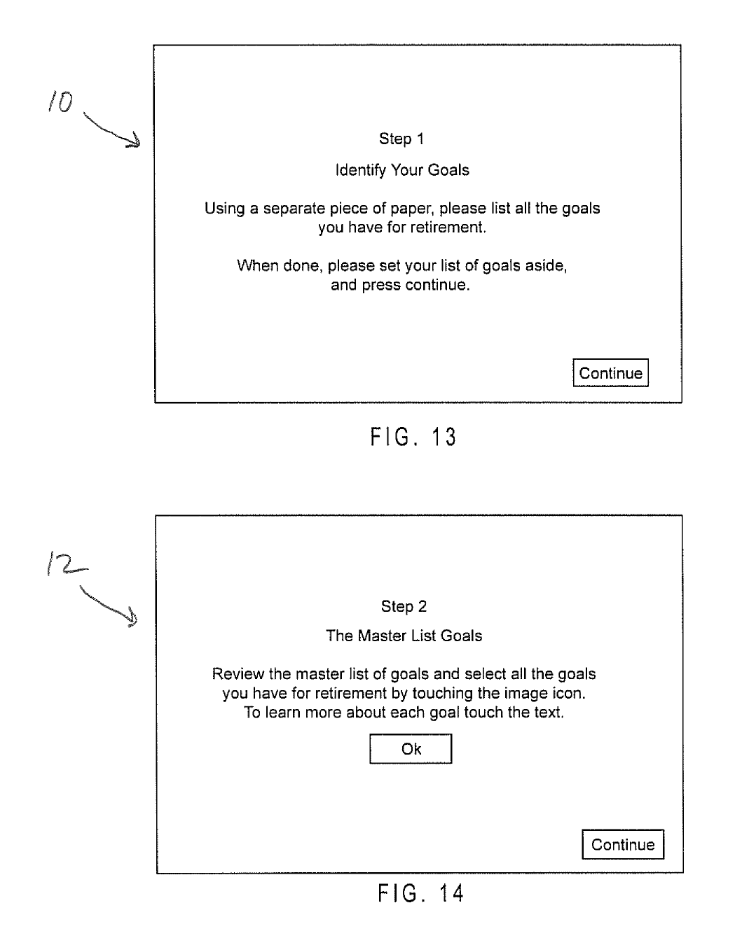

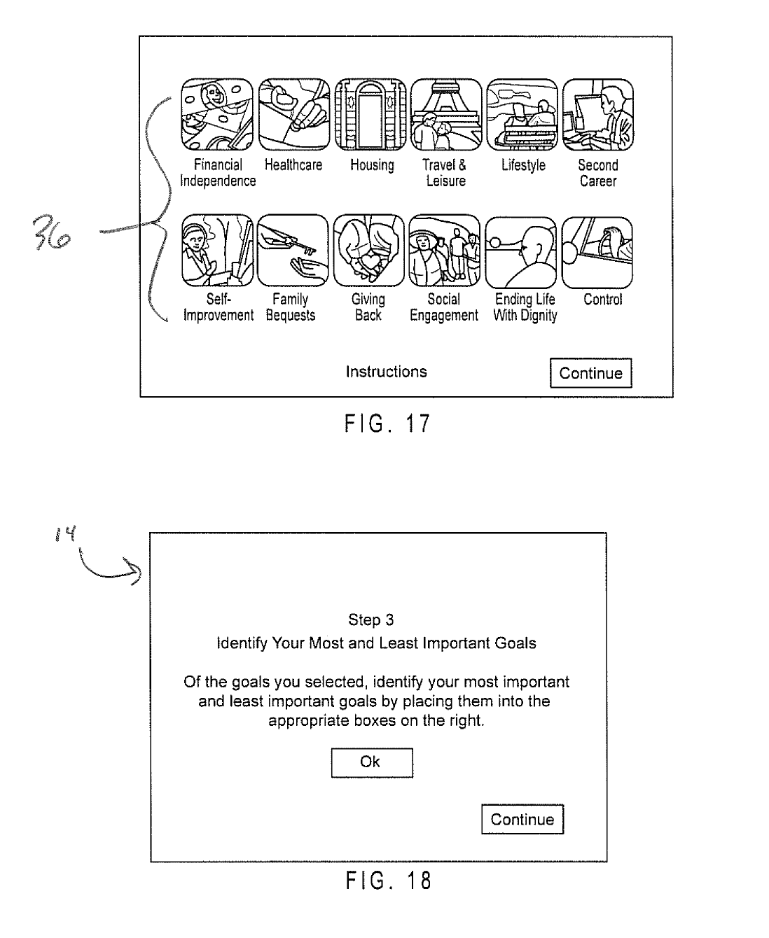

In another embodiment of the new method, the system resides in a computer readable medium, such as a software application for a computer or an iPad application, such as the one depicted in FIGS. 13-29. In this embodiment, the user is first asked to input a list of their goals (FIG. 13). The system records these goals.

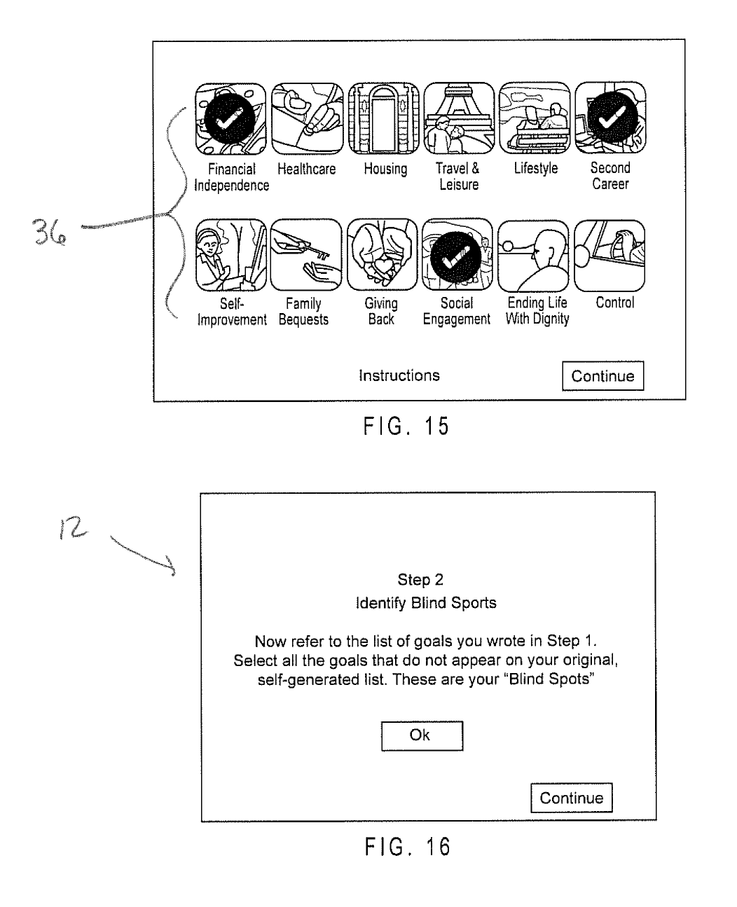

Next, the user is prompted to select goals from this list that are not already on the user-generated list (FIG. 14). The system presents, e.g., as a display on a computer screen or touch screen, a set of goals 36 to the user such as those shown in FIG. 15. The system may display additional information about the presented list of goals 36 to assist a user in evaluating the goal, by displaying instructions to the user to touch the text associated with the goal. Additionally, the goals the user has already input into the system may be shown on one side of the display. If the user attempts to select a goal that is already on their user-generated list, the system recognizes this and notifies the user that the goal is already present. The system may ask the user to select all the goals they selected in the second list that were not on their first list (FIG. 16). These can be identified as the user's “blind spots.”

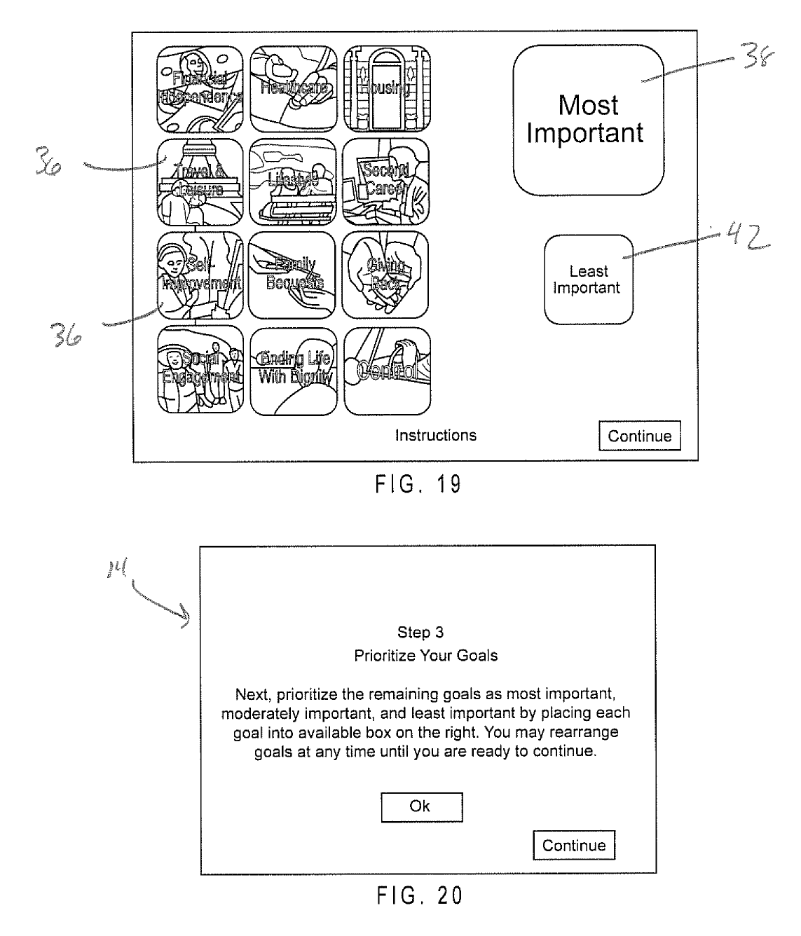

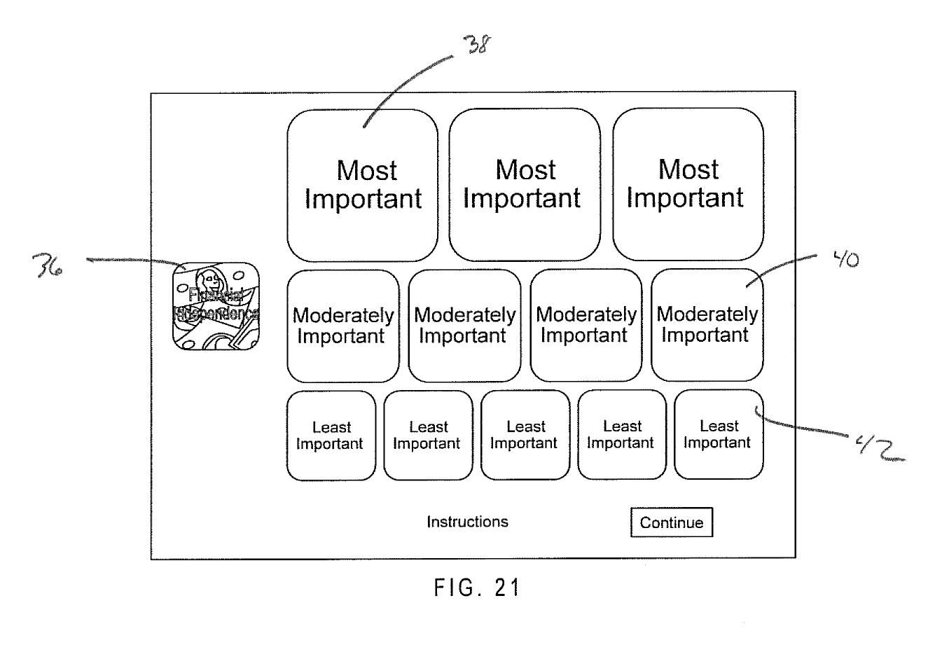

Next, the system displays all the goals 36 from the user-generated list as well as the goals the user chose from the provided list (FIGS. 18 and 19) and asks the user to prioritize the displayed goals 36. The display may show a set of boxes that allow the user to drag and drop their goals 36 into “Most Important” 38 and “Least Important” 42 boxes. The system may then allow the user to prioritize the remaining goals. There may be levels for “Most Important” 38 “Moderately Important” 40, and “Least Important” 42 (FIGS. 20 and 21). Alternatively, the system can prompt the user to arrange the goals 36 in order from least to most important. The most important goals 36 may be displayed in larger icons than the size of the icons for the other goals on the display.

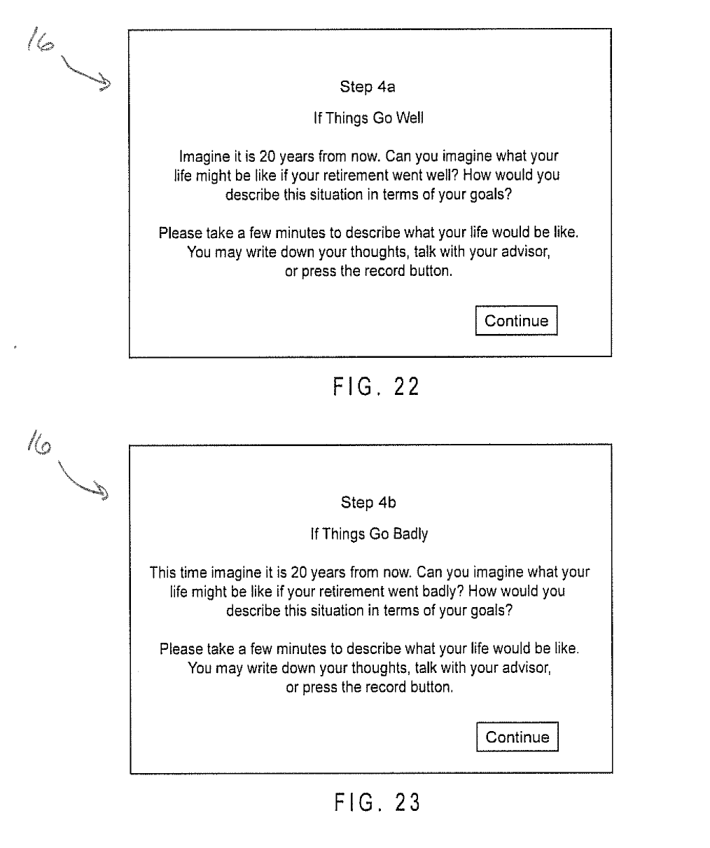

Once the user has prioritized their list of goals 36, the system prompts the user with one or more questions in order to force the user to use prospective hindsight. For example, as shown in FIG. 22, the system may ask the user to imagine what would happen if things go well in terms of their prioritized goals 36. FIG. 23 shows an example of the system asking the user to imagine what would happen if things go poorly in terms of their prioritized goals 36. The user can input their answer by typing it into the system, by speaking their answer into a recording device built into the system, or by any other recording means known in the art and able to get the information into the system.

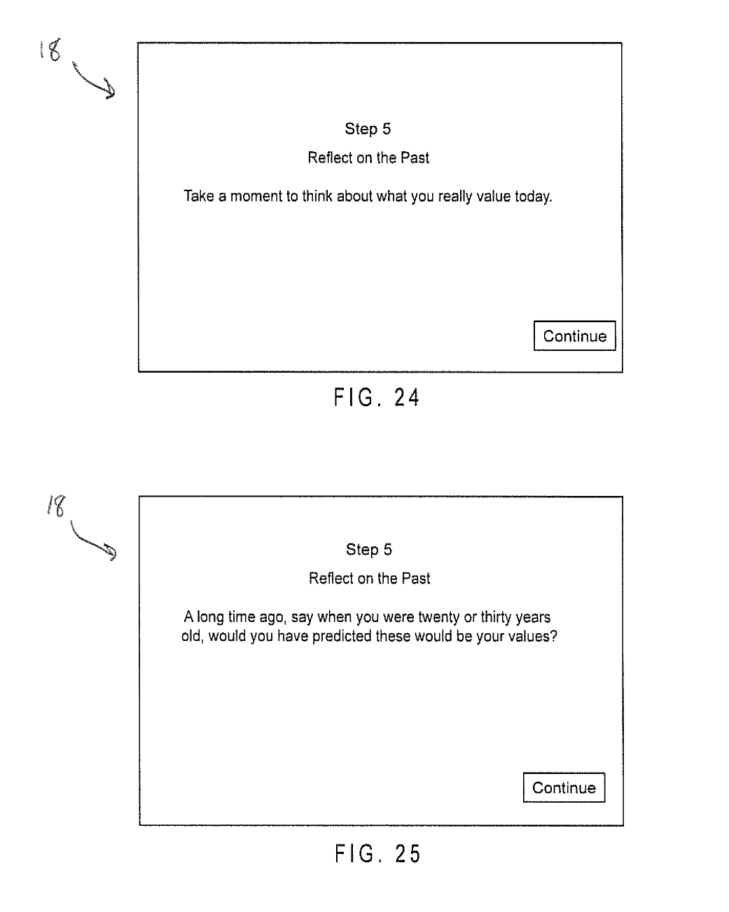

In the next step, shown in FIGS. 24 and 25, the system asks one or more questions designed to force the user to reflect on the limits of their forecasting by, for example, by asking them to reflect on what they really value today and whether, when they were younger, they would have predicted that the identified goals would be their goals 36. When the system poses this question, the user's matrix of prioritized goals 36 may be shown on the screen. The user can input their answer by typing it into the system, by speaking their answer into a recording device built into the system, or by any other recording means known in the art and able to get the information into the system.

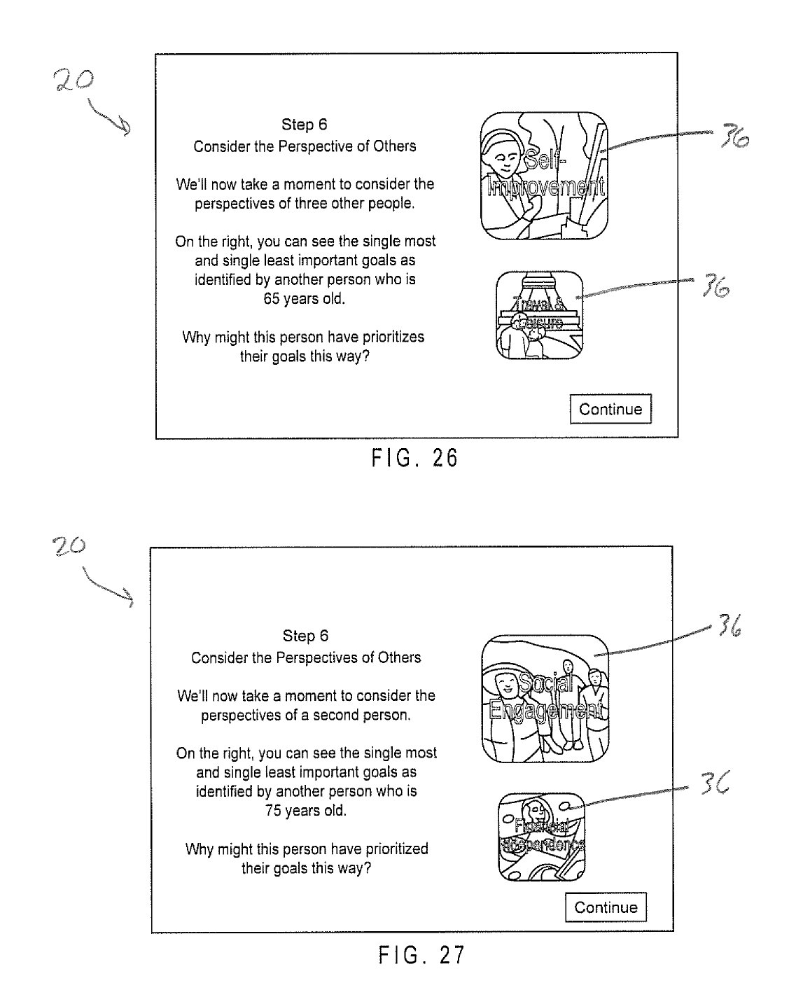

The system then displays an example of another person's prioritized goals 36. For example, as illustrated in FIG. 26, the system shows a 65 year old woman with two children. The system displays her priority matrix and asks the user to consider why that person may have prioritized their goals 36 in that fashion. FIG. 27 shows the system asking the user to consider a second person and their circumstances. The user can input their answer by typing it into the system, by speaking their answer into a recording device built into the system, or by any other recording means known in the art and able to get the information into the system

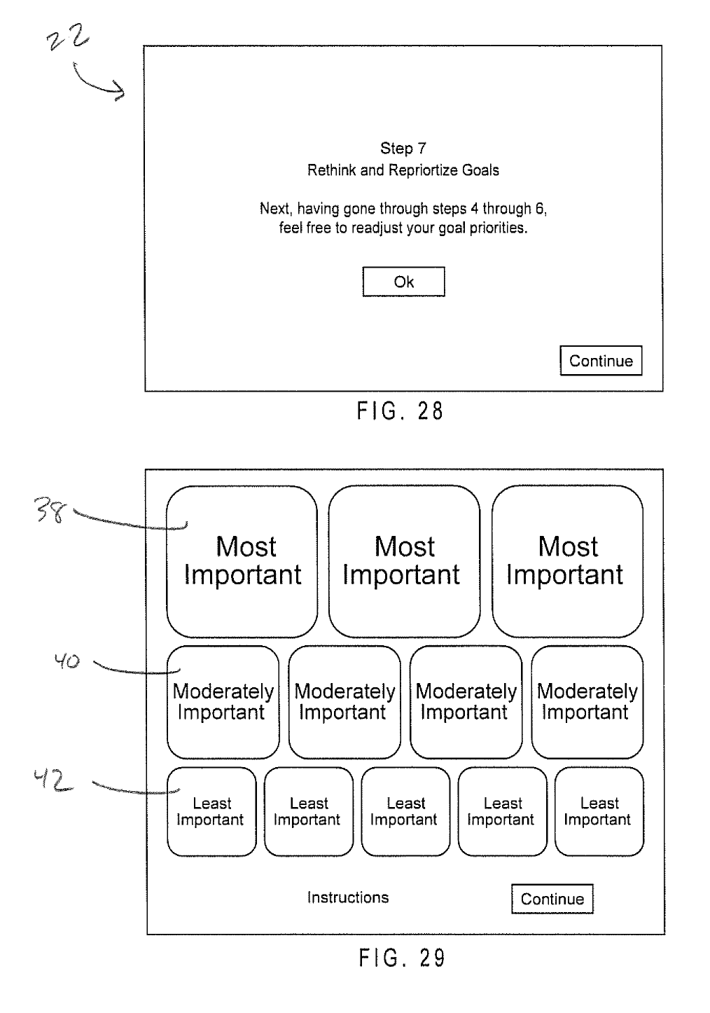

Finally, after the above steps are performed, the system displays the user's prioritized goal matrix and asks the user to reprioritize the goals 36 based on the previous questions and answers in the previous steps (FIGS. 28 and 29). The final matrix may be displayed on screen, emailed to the user, emailed to the user's financial advisor, or printed for later use.

In an addition to displaying the final goal matrix, the systems may calculate and display differences between the user's original weighted set of goals 36 and the final weighted set of goals 36. For example, the system may display new goals 36 that were added, how goals moved (e.g., up or down in priority), how far goals 36 moved (up or down in priority). The differences can be displayed or visualized in a graph or speedometer-type visual representation. Other differences and measurements of differences can be made and displayed as well.

In addition, based on the final goal matrix, the system may also provide a suggested plan or plans for reaching the goals 36. For example, in the context of a retirement planning goal matrix, the system may suggest a financial plan based on the final goal matrix, as well as additional information about the user that is input into the system, such as the user's age, income, assets and liabilities.

In another embodiment, worksheets may be used to perform the steps listed above.

While specific embodiments have been illustrated and described, numerous modifications come to mind without significantly departing from the spirit of the disclosure, and the scope of protection is to be limited only by the scope of the accompanying claims.

What is claimed is:

1. A method of identifying and prioritizing goals for retirement, the method comprising:
obtaining by a computer a list of goals from a user to create a first list;
providing a list of pre-selected goals to the user;
obtaining by a computer the user's preferred goals from the list of pre-selected goals to create a second list;
combining by a computer the first list and the second list into a combined list;
prioritizing by a computer the goals on the combined list based on the user's preferences;
proposing by a computer a first question to the user;
recording by a computer the user's response to the first question; and
reprioritizing by a computer the goals on the combined list based on the user's preferences.

2. The method of claim 1, further comprising the step of proposing by a computer a second question to the user and reprioritizing by a computer the goals on the combined list based on the user's preferences.

3. The method of claim 2, further comprising the step of proposing by a computer a third question to the user and reprioritizing by a computer the goals on the combined list based on the user's preferences.

4. The method of claim 3, further comprising the step of determining by a computer a recommended investment plan.

5. The method of claim 4, further comprising the step of communicating by a computer the recommended investment plan to the user.

6. The method of claim 1, further comprising the step of determining by a computer a recommended retirement plan.

7. The method of claim 6, further comprising the step of communicating by a computer the recommended retirement plan to the user.

8. The method of claim 1, wherein the second question is different than the first question.

9. The method of claim 8, wherein the third question is different than the second question.

10. A method of identifying and prioritizing goals for retirement, the system comprising:
obtaining by a computer a list of goals from a user to create a first list;
providing by a computer a list of pre-selected goals to the user;
obtaining by a computer the user's preferred goals from the list of pre-selected goals to create a second list;
combining by a computer the first list and the second list into a combined list;
prioritizing by a computer the goals on the combined list based on the user's preferences;
proposing by a computer a first question to the user;
recording by a computer the user's response to the first question;
proposing by a computer a second question to the user;
recording by a computer the user's response to the second question;
proposing by a computer a third question to the user;
recording by a computer the user's response to the third question;
reprioritizing by a computer the goals on the combined list based on the user's preferences.

11. The method of claim 10, wherein the first, second and third questions are all different from each other.

12. The method of claim 10, further comprising the step of determining by a computer a recommended retirement plan.

13. The method of claim 12, further comprising the step of communicating by a computer the recommended retirement plan to the user.

14. A method of identifying and prioritizing goals for retirement, the system comprising:
recording a list of goals from a user to create a first list;
providing a list of pre-selected goals to the user;
recording the user's preferred goals from the list of pre-selected goals to create a second list;
combining the first list and the second list into a combined list;
prioritizing the goals on the combined list based on the user's preferences;
proposing a first question to the user;
recording the user's response to the first question; and
reprioritizing the goals on the combined list based on the user's preferences.

15. The method of claim 14, wherein the step of recording is performed by memorializing the user's goals on a first set of tiles.

16. The method of claim 15, wherein the list of pre-recorded goals is provided on a second set of tiles.

17. The method of claim 16, wherein the tiles are attachable to a template.

18. The method of claim 17, wherein the step of prioritizing the goals on the combined list comprises the step of arranging the first and second sets of tiles on the template.

19. The method of claim 18, wherein the template further includes at least one marking upon a surface.

20. The method of claim 19, wherein the step of arranging the first and second sets of tiles on the template further comprises the step of coordinating the tiles with the at least one marking on the template.

21. A computer-readable storage medium having computer-readable code for identifying and prioritizing goals for retirement stored therein, the computer-readable code comprising:
computer-usable program code for obtaining a first list of goals from a user;
computer-usable program code for providing a second list of goals to the user;
computer-usable program code for allowing a user to combine at least parts of the first and second lists of goals;
computer-usable program code for storing the combined first list and second list of goals as a third list of goals;
computer-usable program code for allowing the user to organize the third list of goals by the user's preference;
computer-usable program code for storing the organized third list;
computer-usable program code for displaying at least one question to the user; and
computer-usable program code for allowing the user to reorganize the third list of goals after displaying the at least one question.

22. The computer-readable storage medium of claim 21, wherein further comprising computer-usable program code for displaying at least a second question to the user.

23. The computer-readable storage medium of claim 22, wherein further comprising computer-usable program code for displaying at least a third question to the user.

24. The computer-readable storage medium of claim 21, further comprising computer-readable program code for calculating the differences between the organized third list of goals and the reorganized third list of goals.

25. The computer-readable storage medium of claim 24, further comprising computer-readable program code for displaying the differences between the organized third list of goals and the reorganized third list of goals.
